(19) United States
(12) Patent Application Publication
(10) Pub. No.: US 2025/0058681 A1
(43) Pub. Date: Feb. 20, 2025

(54) CHILD RESTRAINT

(71) Applicant: Dorel Juvenile Group, Inc., Foxboro, MA (US)

(72) Inventors: Nathan W. HEISEY, Seymour, IN (US); Jason H. JOHNSON, Brownstown, IN (US); Matthew R. LARRISON, Columbus, IN (US); Grant M. MASON, Wrentham, MA (US)

(21) Appl. No.: 18/807,421

(22) Filed: Aug. 16, 2024

Related U.S. Application Data
(60) Provisional application No. 63/533,221, filed on Aug. 17, 2023.
(60) Provisional application No. 63/580,543, filed on Sep. 5, 2023.

(51) Int. Cl. B60N 2/26; B60N 2/06; B60N 2/28

(52) U.S. Cl. CPC B60N 2/268; B60N 2/062; B60N 2/2821

(57) ABSTRACT

A child restraint includes a juvenile seat and a seat base. The juvenile seat is formed to include a child-receiving space configured to hold a child for transportation in a vehicle. The seat base configured to be secured to a vehicle seat to mount the juvenile seat to the vehicle seat during transportation in the vehicle. The juvenile seat is movable relative to the seat base.

### PRIORITY CLAIM

This application claims priority under 35 U.S.C. § 119 (e) to U.S. Provisional Patent Application No. 63/533,221, filed Aug. 17, 2023, and to U.S. Provisional Patent Application No. 63/580,543, filed Sep. 5, 2023, each of which is expressly incorporated by reference herein in its entirety.

### BACKGROUND

The present disclosure relates to a safety device, and particularly to car seat. More particularly, the present disclosure relates to a child car seat.

### SUMMARY

According to the present disclosure, a child restraint includes a juvenile seat and a seat base. The juvenile seat is formed to include a child-receiving space configured to hold a child for transportation in a vehicle. The seat base is configured to be secured to a vehicle seat to mount the juvenile seat to the vehicle seat during transportation in the vehicle.

In illustrative embodiments, the child restraint further includes a translation system configured to support the juvenile seat on the seat base and allow movement of the juvenile seat relative to the seat base between a transportation position and an ingress-egress position. In the transportation position, the juvenile seat lies along a front-to-back centerline of the seat base. In the ingress-egress position, a front-to back centerline of the juvenile seat is offset from and parallel to the front-to-back centerline of the seat base to facilitate placement or removal of a child into or out of the child-receiving space, or to install or remove the juvenile seat from the seat base, while standing outside of the vehicle.

In illustrative embodiments, the translation system includes a juvenile-seat shuttle coupled to the seat base, a shuttle-guide system coupled between the juvenile-seat shuttle and the seat base, and a shuttle lock. The juvenile-seat shuttle is configured to engage with the juvenile seat to support the juvenile seat on the seat base for movement between the transportation position and the ingress-egress position. The shuttle-guide system is configured to guide sliding movement of the juvenile-seat shuttle and the juvenile seat relative to the seat base in a lateral direction between the transportation position and the ingress-egress position. The shuttle lock is configured to block movement of the juvenile-seat shuttle relative to the seat base from the transportation position to the ingress-egress position and from the ingress-egress position to the transportation position.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a child restraint, in accordance with the present disclosure, including a seat base, a juvenile seat adapted to be coupled to the seat base and secured to a vehicle seat by the seat base, and a translation system coupled to the seat base and configured to mount the juvenile seat to the seat base in a transportation position within the vehicle;

FIG. 2 is a perspective view of the child restraint showing that the translation system includes a juvenile-seat shuttle configured to couple to the juvenile seat, a shuttle-guide system configured to guide movement of the juvenile-seat shuttle and the juvenile seat in a lateral direction from the transportation position to an ingress-egress position in which the juvenile seat and the juvenile-seat shuttle are at least partially offset from the seat base to facilitate placement or removal of a child to and from the juvenile seat, and a shuttle lock configured to block movement of the juvenile-seat shuttle relative to the seat base;

FIG. 3 is a cross section taken along line 3-3 in FIG. 1 showing that the shuttle lock includes a first actuator coupled to a first lateral side of the juvenile-seat shuttle and a second actuator coupled to a second lateral side of the juvenile-seat shuttle opposite the first lateral side, the first actuator is configured to move from a locked position to an unlocked position to free the juvenile-seat shuttle to slide in a first lateral direction to arrange the juvenile-seat shuttle in a first ingress-egress position, as shown in FIGS. 2 and 6, and the second actuator is configured to move from a locked position to an unlocked position to free the juvenile-seat shuttle to slide in a second lateral direction opposite the first lateral direction to arrange the juvenile-seat shuttle in a second ingress-egress position;

FIG. 4 is an enlarged cross section of the first actuator showing the first actuator includes a shuttle retainer configured to engage the seat base in the locked position and a handle configured to be grasped by a user to change the first actuator from the locked position to the unlocked position;

FIG. 5 is an enlarged cross section of the first actuator in the unlocked position to separate the shuttle retainer from the seat base so that the juvenile-seat shuttle is free to slide relative to the seat base;

FIG. 6 is a cross section taken along line 6-6 in FIG. 2 showing the juvenile-seat shuttle in the ingress-egress position;

FIG. 7 is a perspective view of the cross section of FIG. 6 showing that the second actuator includes a second shuttle retainer configured to engage a detent in the ingress-egress position to block movement of the juvenile-seat shuttle from the ingress-egress position to the transportation position;

FIG. 8 is an exploded assembly view showing the juvenile-seat shuttle separated from the seat base to show that the shuttle-guide system includes a plurality of rails coupled to an upper surface of the seat base and a plurality of shuttle anchors coupled to the juvenile-seat shuttle to interlock with the plurality of rails and block separation of the juvenile-seat shuttle from the seat base;

FIG. 9 is a side elevation view of the seat base and the translation system showing the plurality of rails received in corresponding slots formed in the juvenile-seat shuttle;

FIG. 10 is a cross section taken along line 10-10 in FIG. 1 showing that the translation system further includes a translation limiter configured to block further movement of the juvenile-seat shuttle relative to the seat base past the ingress-egress position;

FIG. 11 is a cross section taken along line 11-11 in FIG. 2 showing the translation limiter engaged with portions of the juvenile-seat shuttle and the seat base to block further movement of the juvenile-seat shuttle relative to the seat base past the ingress-egress position;

FIG. 12 is a cross section taken along line 12-12 in FIG. 1 showing that the translation system further includes a position indicator configured to indicate when the juvenile-seat shuttle is in the transportation position and when the juvenile-seat shuttle is not in the transportation position;

FIG. 13 is an enlarged view of a portion of FIG. 12 showing the position indicator displaying a first visual indication when the juvenile-seat shuttle is in the transportation position;

FIG. 14 is a cross section taken along line 14-14 in FIG. 2 showing the juvenile-seat shuttle in the ingress-egress position;

FIG. 15 is an enlarged view of a portion of FIG. 14 showing the position indicator displaying a second visual indication when the juvenile-seat shuttle is not in the transportation position;

FIG. 16 is a perspective view of another embodiment of a child restraint, in accordance with the present disclosure, including a seat base, a juvenile seat, and a juvenile-seat shuttle in a transportation position;

FIG. 17 is a perspective view of the child restraint showing the juvenile-seat shuttle and the juvenile seat in an ingress-egress position;

FIG. 18 is a cross section taken along line 18-18 in FIG. 16;

FIG. 19 is an enlarged view of a portion of FIG. 18 showing a first actuator in a locked position blocking movement of the juvenile-seat shuttle relative to the seat base;

FIG. 20 is an enlarged view of a portion of the child restraint showing the first actuator in an unlocked position to free the juvenile-seat shuttle for movement relative to the seat base;

FIG. 21 is a cross section taken along line 21-21 in FIG. 17 showing the juvenile-seat shuttle in the ingress-egress position;

FIG. 22 is a perspective view and cross section of the child restraint showing the juvenile-seat shuttle in the ingress-egress position;

FIG. 23 is an exploded assembly view of the child restraint showing the juvenile-seat shuttle separated from the seat base;

FIG. 24 is a side elevation view of the child restraint;

FIG. 25 is a perspective view of another embodiment of a child restraint including a seat base, a juvenile seat, and a juvenile-seat shuttle showing the juvenile seat and the juvenile-seat shuttle in a transportation position;

FIG. 26 is a perspective view of the child restraint showing the juvenile seat and the juvenile-seat shuttle in an ingress-egress position;

FIG. 27 is a perspective view of the child restraint showing a shuttle lock in a locked position blocking movement of the juvenile-seat shuttle relative to the seat base;

FIG. 28 is a perspective view of the child restraint showing a shuttle lock in an unlocked position to free the juvenile-seat shuttle for movement relative to the seat base;

FIG. 29 is a perspective view of the child restraint showing the juvenile-seat shuttle in the ingress-egress position and the shuttle lock engaged with a detent to block movement of the juvenile-seat shuttle from the ingress-egress position to the transportation position; and

FIG. 30 is a perspective view of the child restraint showing a plurality of rails coupled to the seat base and received in a plurality of slots formed in the juvenile-seat shuttle to guide lateral sliding movement of the juvenile-seat shuttle relative to the seat base.

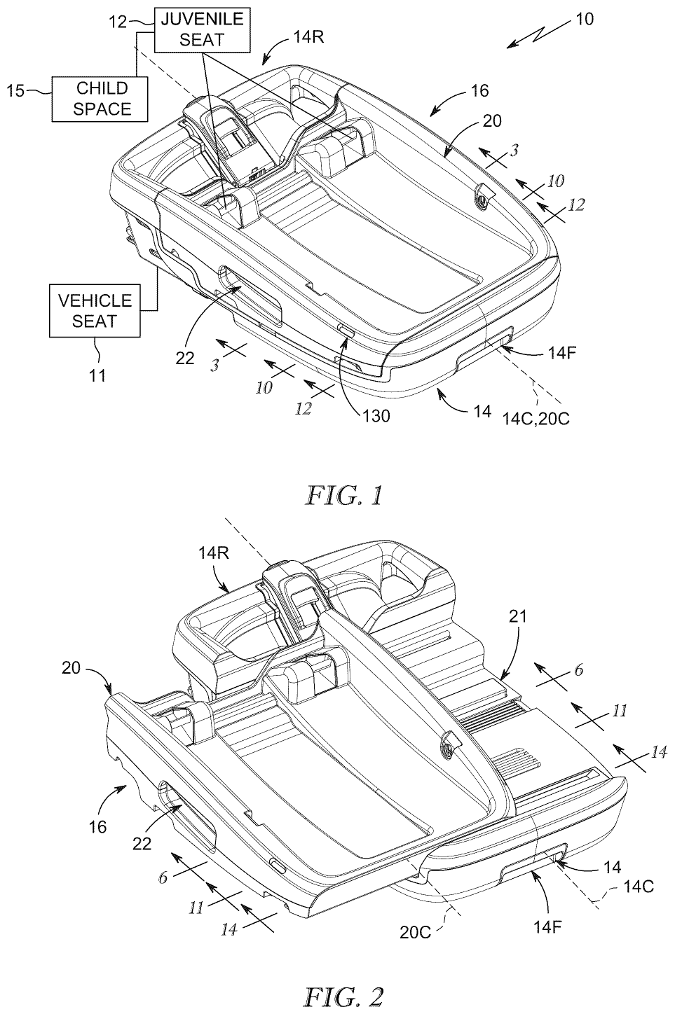

### DETAILED DESCRIPTION

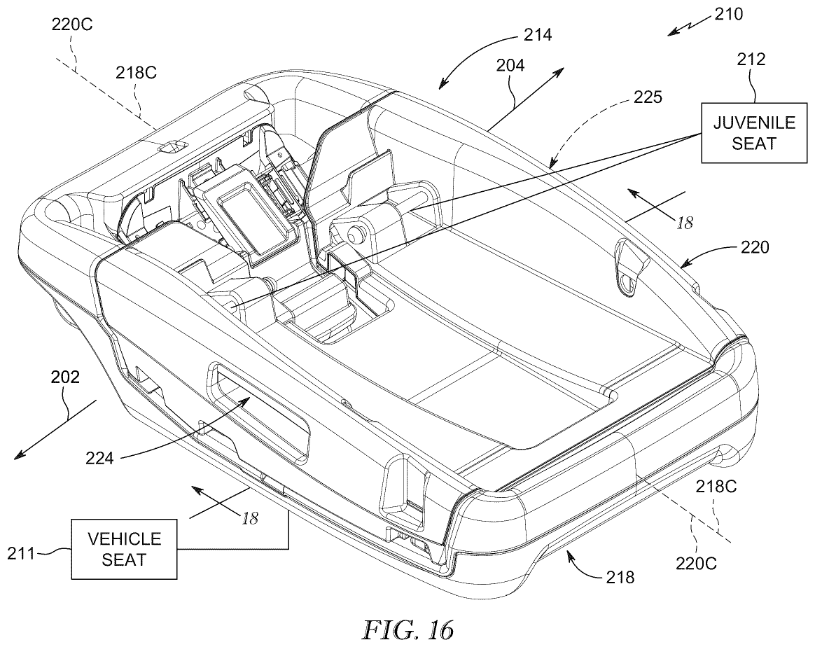

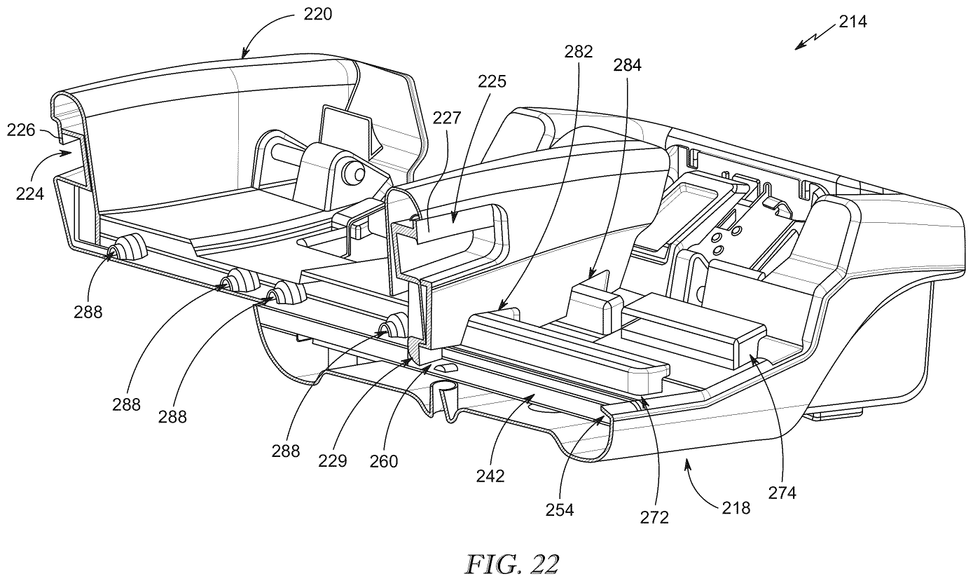

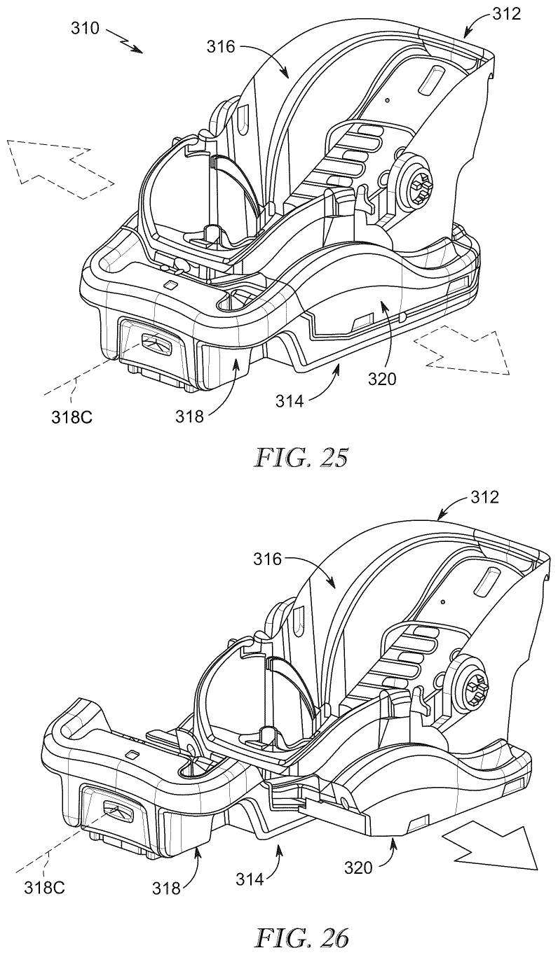

A child restraint 10 includes a juvenile seat 12 and a seat base 14. The juvenile seat 12 is formed to include a child-receiving space 15 configured to hold a child for transportation in a vehicle. The seat base 14 is configured to be secured to a vehicle seat 11 to mount the juvenile seat 12 to the vehicle seat 11 during transportation in the vehicle. In some embodiments, the juvenile seat 12 may be separated from the seat base 14 for transportation away from the seat base 14 and the vehicle seat 11. A second embodiment of a child restraint 210 is shown in FIGS. 16-24. A third embodiment of a child restraint 310 is shown in FIGS. 25-30.

In illustrative embodiments, the child restraint 10 further includes a translation system 16 configured to mount the juvenile seat 12 to the seat base 14 for movement relative to the seat base 14 for easier loading and unloading of the child to and from the juvenile seat 12. The translation system 16 includes a juvenile-seat shuttle 20, a shuttle-guide system 21, and a shuttle lock 22. The juvenile-seat shuttle 20 is coupled to the seat base 14 and is configured to engage with the juvenile seat 12 to support the juvenile seat one the seat base 14 for movement between a transportation position and an ingress-egress position. The shuttle-guide system 21 is coupled between the juvenile-seat shuttle 20 and the seat base 14 and is configured to guide sliding movement of the juvenile-seat shuttle 20 and the juvenile seat 12 relative to the seat base 14 in a lateral direction between the transportation position and the ingress-egress position. The shuttle lock 22 is configured to block movement of the juvenile-seat shuttle 20 relative to the seat base 14 from the transportation position to the ingress-egress position and from the ingress-egress position to the transportation position.

In the transportation position, the juvenile seat 14 and the juvenile-seat shuttle 20 overlie the seat base 14 as shown in FIG. 1. The seat base 14 and the juvenile-seat shuttle 20 each have front-to-back centerlines 14C, 20C that are aligned in the transportation position. In the ingress-egress position, the juvenile-seat shuttle 20 and the juvenile seat 12 are at least partially offset from the seat base 14 to facilitate placement or removal of a child into or out of the child-receiving space. In some embodiments, the juvenile-seat shuttle 20 and the juvenile seat 12 may be offset from the centerline 14C in the ingress-egress position such that the juvenile-seat shuttle 20 and the juvenile seat 12 project outward from the base foundation 18 more than half a width of the seat base 14. The juvenile-seat shuttle 20 is configured to slide the juvenile seat 12 closer to, or even partially outside of, a door of the vehicle while the child restraint 10 is attached to the vehicle seat 11 so that it is easier for a caregiver to install or remove a child from the child-receiving space, or to install or remove the juvenile seat 12 from the seat base 14, while standing outside of the vehicle. The centerlines 14C, 20C remain parallel to one another in the ingress-egress position.

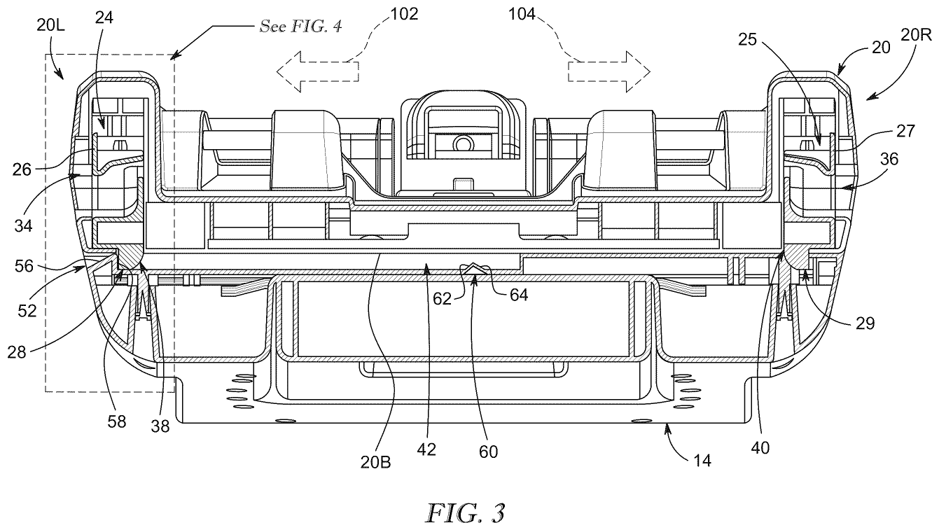

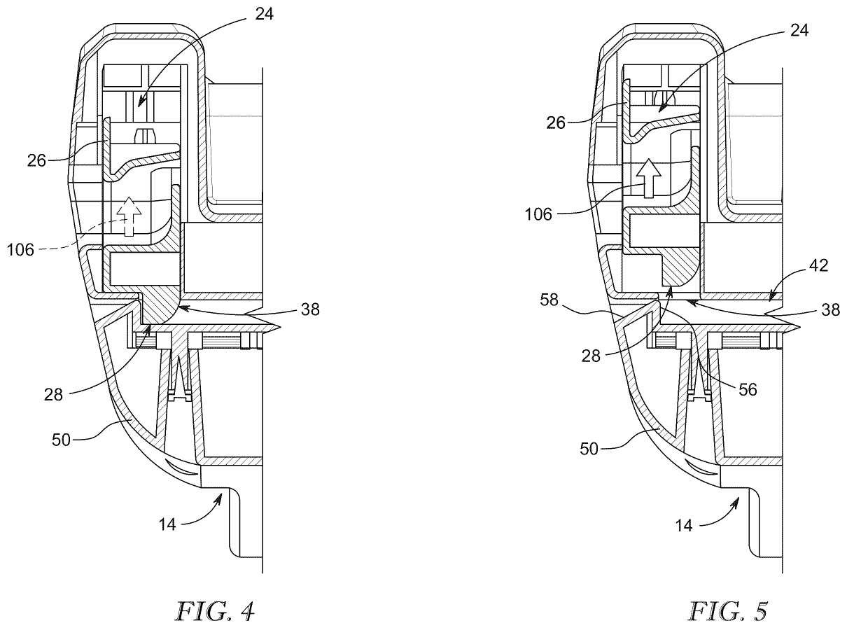

The shuttle lock 22 is configured to retain selectively the juvenile-seat shuttle 20 and the juvenile seat 12 in the transportation position as shown in FIGS. 3 and 4. The shuttle lock 22 includes left and right actuators 24, 25 located on opposite lateral sides 20L, 20R of the juvenile-seat shuttle 20 from one another. The juvenile-seat shuttle 20 can slide linearly to the left or right upon actuation of either of the left or right actuators 24, 25. In some embodiments, the juvenile-seat shuttle 20 may be configured to slide linearly in a left direction 102 only upon actuation of the left actuator 24 and in an opposite, right direction 104 only upon actuation of the right actuator 25. In some embodiments, the juvenile-seat shuttle 20 may be configured to slide in either direction 102, 104 upon actuation of either actuator 24, 25. In some embodiments, the left and right actuators 24, 25 can be coupled to one another so that actuation of one of the actuators 24, 25 causes simultaneous actuation of the other actuator 24, 25.

Each actuator 24, 25 includes a handgrip 26, 27 and a shuttle retainer 28, 29 coupled to each respective handgrip 26, 27 as shown in FIGS. 3-5. The handgrips 26, 27 are located within respective cavities 30, 32 formed in the juvenile-seat shuttle 20 and are accessible through openings 34, 36 formed in each lateral side 20L, 20R of the juvenile-seat shuttle 20. The shuttle retainers 28, 29 are coupled to lower ends of each respective handgrip 26, 27 and extend downwardly toward the seat base 14. Each of the shuttle retainers 28, 29 is configured to extend out of each respective cavity 30, 32 through an opening 38, 40 formed in a bottom wall 20B of the juvenile-seat shuttle 20. The shuttle retainers 28, 29 are normally positioned to engage the seat base 14 to block movement of the juvenile-seat shuttle 20 relative to the seat base 14 from the transportation position to the ingress-egress position.

Each of the handgrips 26, 27 can be gripped and moved in an upward direction 106 away from the seat base 14 by a user to change the shuttle lock 22 from a locked position, as shown in FIG. 4, to an unlocked position, as shown in FIG. 5. In the locked position, the each of the shuttle retainers 28, 29 extend through each respective opening 38, 40 toward the seat base 14. Each shuttle retainer 28, 29 extends into a slot 42 formed in the seat base 14 and engages a portion of the seat base 14 in the locked position to block movement of the juvenile-seat shuttle 20 to the ingress-egress position. In the unlocked position, at least one of the shuttle retainers 28, 29 is removed from the slot 42 in the upward direction 106 and the juvenile-seat shuttle 20 is free to slide relative to the seat base 14 to the ingress-egress position.

The seat base 14 includes a base foundation 50 and left and right motion blockers 52, 54 coupled to opposite lateral sides of the base foundation 50. The base foundation 50 is formed to include the slot 42 that receives the shuttle retainers 28, 29 in the locked position. Each motion-blocker 52, 54 is positioned at an outermost end of the slot 42 and includes a retaining surface 56, and a sloped surface 58. Each shuttle retainer 28, 29 is configured to bear against a respective retaining surface 56 in the locked position to block the juvenile-seat shuttle 20 from sliding relative to the seat base 14 to the ingress-egress position. Each sloped surface 58 is configured to move the shuttle retainers 28, 29 out of the way of the base foundation 50 as the juvenile-seat shuttle 20 returns to the transportation position. In the illustrative embodiment, the actuators 24, 25 are biased (i.e. by a spring or gravity) downwardly toward the seat base 14 to automatically assume the locked position when the juvenile-seat shuttle 20 returns to the transportation position.

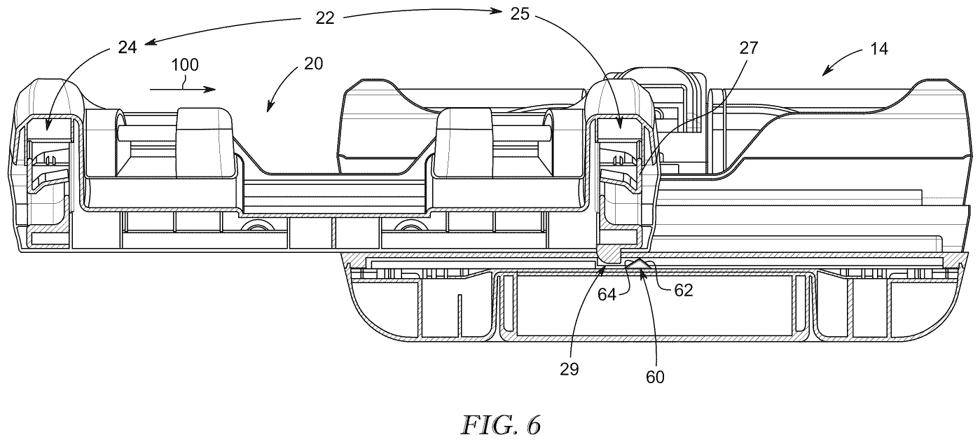

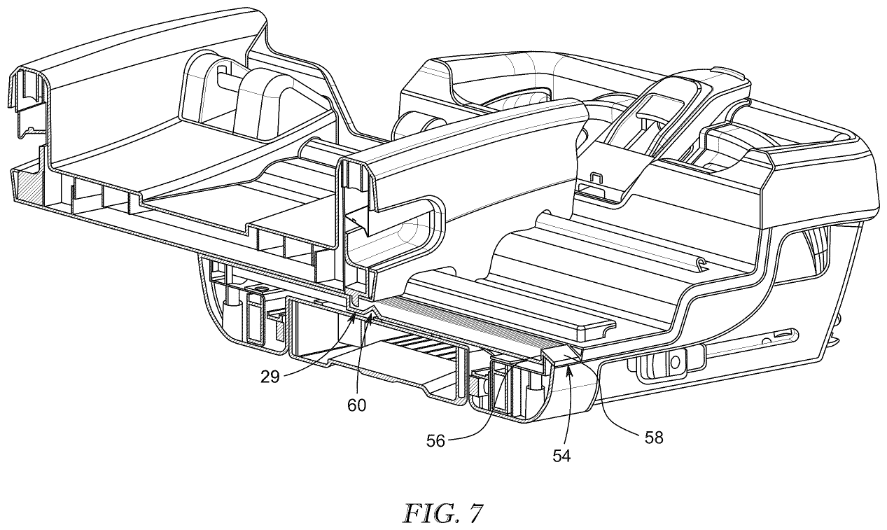

The shuttle lock 22 is also configured to retain the juvenile-seat shuttle 20 in the ingress-egress position as shown in FIG. 6. The base foundation 18 further includes at least one detent 60 configured to retain the juvenile-seat shuttle 20 in the ingress-egress position and block movement of the juvenile-seat shuttle 20 toward the transportation position. The detent 60 is located within the slot 42 and is spaced inwardly from the motion blockers 52, 54 to reside between the motion blockers 52, 54. The detent 60 is configured to interact with one of the shuttle retainers 28, 29 in the ingress-egress position to block movement of the juvenile-seat shuttle 20 toward the transportation position. The detent 60 lies vertically within a travel path of one of the shuttle retainers 28, 29 to control movement of the juvenile-seat shuttle 20 from the ingress-egress position to the transportation position.

The detent 60 includes a pair of sloped surfaces 62, 64 that are inclined toward one another. The sloped surfaces 62, 64 allow movement of the shuttle retainers 28, 29 over and past the detent 60 in response to a lateral force 100 above a predetermined amount. The sloped surfaces 62, 64 may have different slopes relative to one another so that the predetermined amount required to overcome the detent 60 is different when juvenile-seat shuttle travels from the transportation position to the ingress-egress position and from the ingress-egress position to the transportation position. In the illustrative embodiment, the sloped surface 64 that engages the shuttle retainer 28, 29 first as the juvenile-seat shuttle 20 moves from the transportation position to the ingress-egress position has a greater slope than the sloped surface 62 that engages the shuttle retainer 28, 29 first as the juvenile-seat shuttle 20 moves from the ingress-egress position to the transportation position. The juvenile-seat shuttle 20 may further include rollers 88 that engage and roll along the seat base 14 to facilitate movement from between the transportation position and the ingress-egress position.

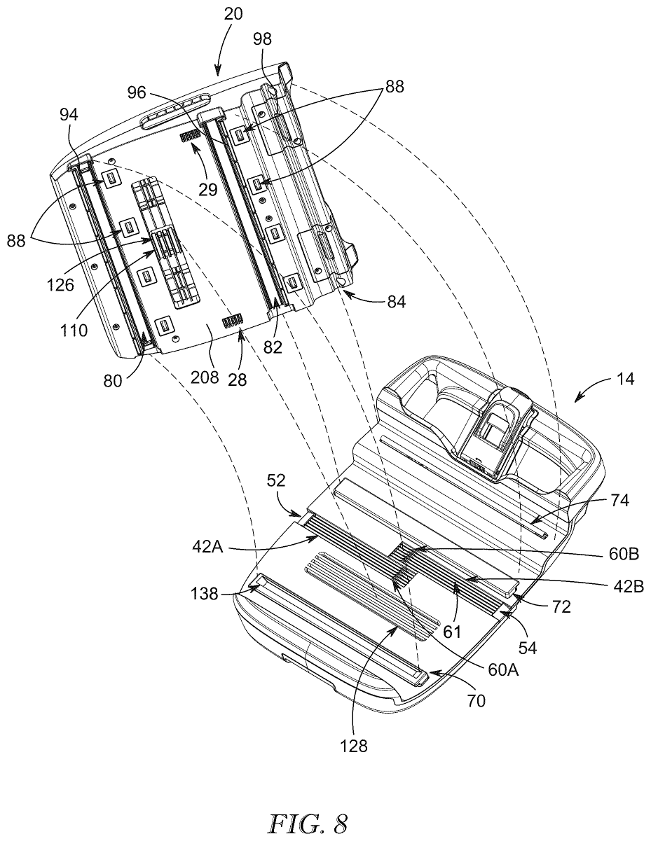

In the illustrative embodiment, slot 42 includes two portions 42A, 42B that are at least partially offset from one another as shown in FIG. 8. Each of the portions 42A, 42B of the slot 42 extends linearly from a central region of the base foundation 50 toward a respective lateral side of the base foundation. Each of the shuttle retainers 28, 29 is configured to extend into a respective portion 42A, 42B of the slot 42 and travel therethrough. The detent 60 includes first and second detents 60A, 60B, each arranged in a respective portion 42A, 42B. In the illustrative embodiment each of the shuttle retainers 28, 29 is segmented to form plurality of ribs at a distal end of each shuttle retainer 28, 29 as shown in FIG. 8. The seat base is formed to include a plurality of slots 61 in both portion 42A, 42B of the slot 42 which receive the ribs of the shuttle retainers 28, 29 and help guide lateral movement of the juvenile-seat shuttle 20 relative to the seat base 14. The detent 60 includes a portion formed in each of the slots 61 to engage with a corresponding rib included in each shuttle retainer 28, 29 when the juvenile-seat shuttle 20 is in the ingress-egress position.

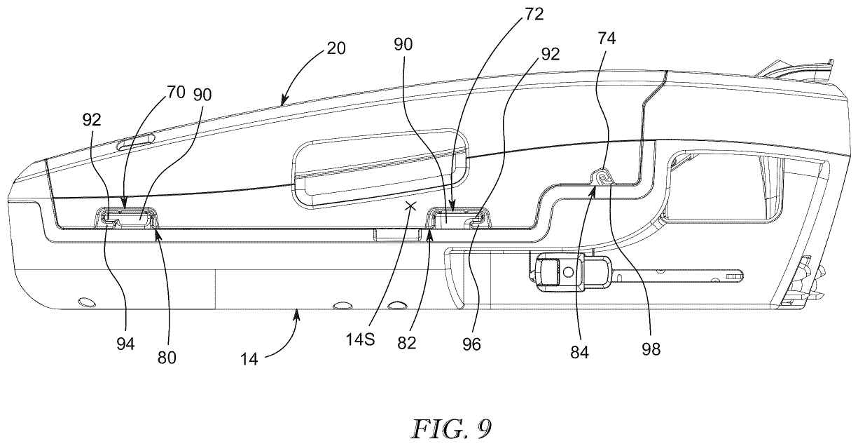

The shuttle-guide system 21 includes a plurality of rails 70, 72, 74 coupled to an upper end of the base foundation 50 and a plurality of shuttle anchors 94, 96, 98 coupled to the juvenile-seat shuttle 20 as shown in FIGS. 8 and 9. Each rail 70, 72, 74 is configured to interlock with a respective shuttle anchor 94, 96, 98 to block separation of the juvenile-seat shuttle from the seat base 14 and allow lateral sliding of the juvenile-seat shuttle 20 relative to the seat base 14.

The juvenile-seat shuttle 20 is formed to include a plurality of guide slots 80, 82, 84 as shown in FIGS. 8 and 9. Each rail 70, 72, 74 is received in a respective guide slot 80, 82, 84. The juvenile-seat shuttle 20 and the juvenile seat 12 are configured to slide laterally relative to the base foundation 18 to cause each rail 70, 72, 74 to be partially removed from each respective guide slot 80, 82, 84 in the ingress-egress position.

Each rail 70, 72, 74 may include a rail body 90 and a hanger 92 that extends horizontally away from an upper end of the rail body 90 as shown in FIGS. 8 and 9. Each respective shuttle anchor 94, 96, 98 is located beneath a respective hanger 92 to block separation of the juvenile-seat shuttle 20 away from the base foundation 50 in an upward direction. In the illustrative embodiment, two rails 72, 74 are located closer to the rear end 14R of the seat base 14 than a front end 14F to reinforce connection with the juvenile-seat shuttle 20 at the rear end 14R and bear loads acting thereon during front end impacts on the vehicle.

The plurality rails 70, 72, 74 includes a first rail 70, a second rail 72, and a third rail 74 as shown in FIGS. 8 and 9. The first rail 70 is located between the rear end 14R of the seat base 14 and a side-to-side centerline 14S of the seat base 14 extending perpendicular to the front-to-back centerline 14C. The second rail 72 is located between the first rail 70 and the side-to-side centerline 14S of the seat base 14. The third rail 74 is located between the front end 14F of the seat base 14 and the side-to-side centerline 14S of the seat base 14.

The plurality of shuttle anchors 94, 96, 98 includes a first shuttle anchor 94, a second shuttle anchor 96, and a third shuttle anchor 98 as shown in FIGS. 8 and 9. The first shuttle anchor 94 is configured to interlock with the first rail 70 and extends toward the side-to-side centerline 14S. The second shuttle anchor 96 is configured to interlock with the second rail 72 and extends toward the side-to-side centerline 14S. The third shuttle anchor 98 is configured to interlock with the third rail 74 and extends toward the side-to-side centerline 14S.

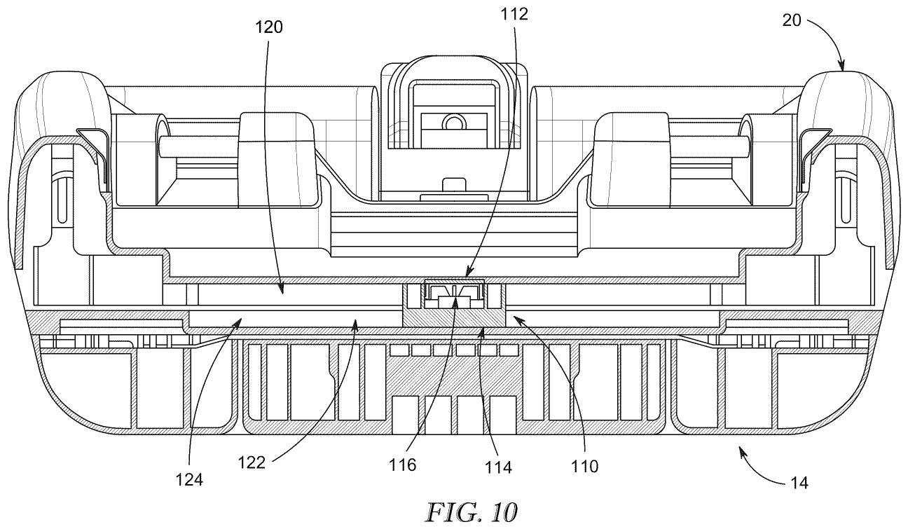

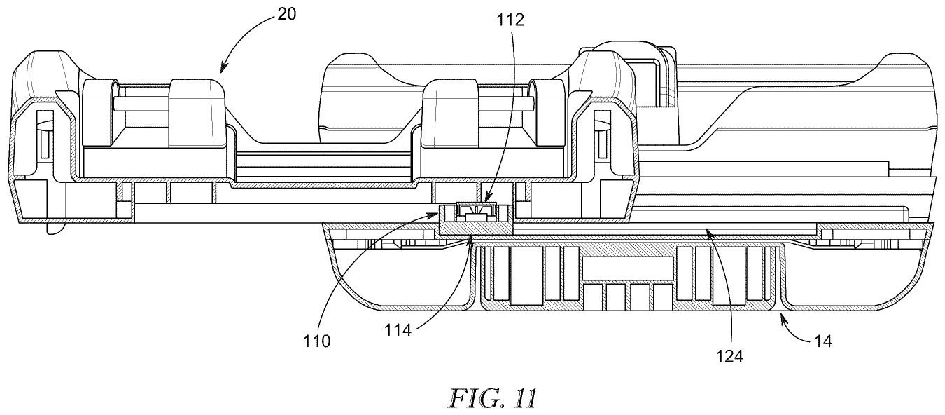

In the illustrative embodiment, the shuttle-guide system 21 further includes a translation limiter 110 spaced apart from the shuttle lock 22 and configured to engage the seat base 14 when the juvenile-seat shuttle 20 is in the ingress-egress position to block further translation of the juvenile-seat shuttle 20 relative to the seat base 14. The translation limiter 110 includes an upper limiter body 112, a lower limiter body 114, and a biasing element 116 as shown in FIGS. 10 and 11. The upper limiter body 112 is engaged with the juvenile-seat shuttle 20. The lower limiter body 114 is engaged with the seat base 14. The biasing element 116 biases the upper limiter body 112 and the lower limiter body 116 away from one another and into the juvenile-seat shuttle 20 and the seat base 14, respectively.

The translation limiter 110 is configured to slide relative to the juvenile-seat shuttle and relative to the seat base 14 as the juvenile seat 12 and the juvenile-seat shuttle moves between the transportation position and the ingress-egress position. In the ingress-egress position, the translation limiter 110 engages portions of both the seat base 14 and the juvenile-seat shuttle 20 to block further movement of the juvenile seat 12 and the juvenile-seat shuttle 20 past the ingress-egress position.

The juvenile-seat shuttle 20 is formed to include a first limiter-receiving slot 120 and the seat base 14 is formed to include a second limiter-receiving slot 122 aligned with the first limiter-receiving slot 122 to define a limiter cavity 124 therebetween. The translation limiter 110 is positioned in the limiter cavity 124 and is configured to slide relative to the seat base 14 and the juvenile-seat shuttle 20 as the juvenile-seat shuttle moves between the transportation position and the ingress-egress position. The lower limiter base 112 includes a first plurality of ribs 126 and the seat base 14 is formed to include a second plurality of ribs 128 in the second limiter-receiving slot 122. The first and second plurality of ribs 126, 128 interlock with one another to limit movement and twisting of the juvenile-seat shuttle 20 relative to the seat base 14.

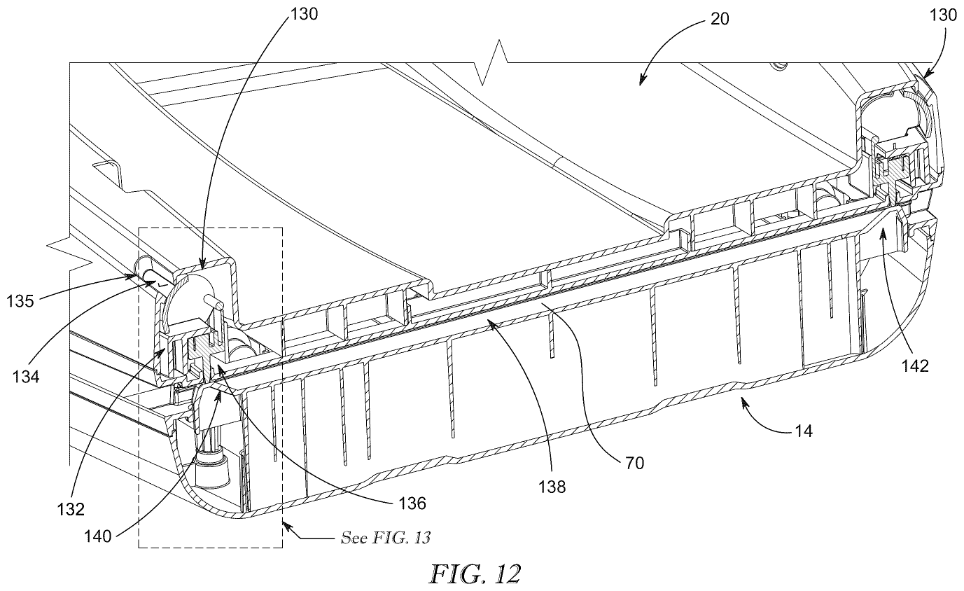

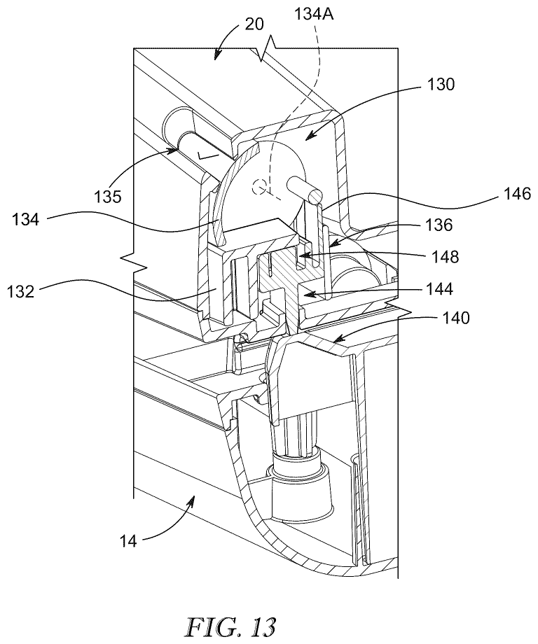

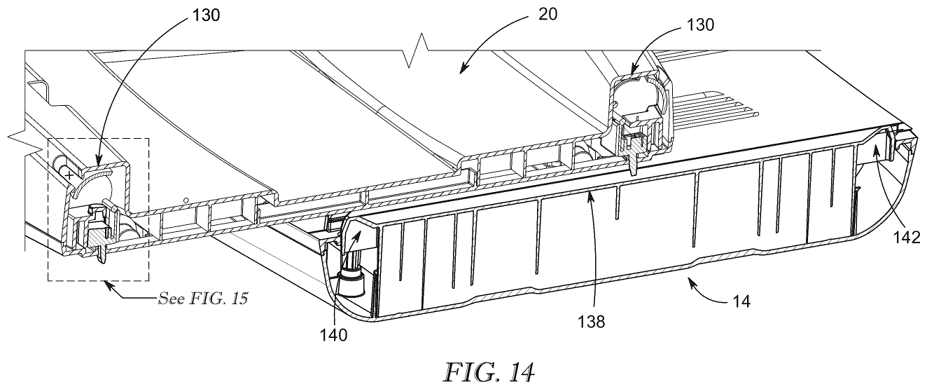

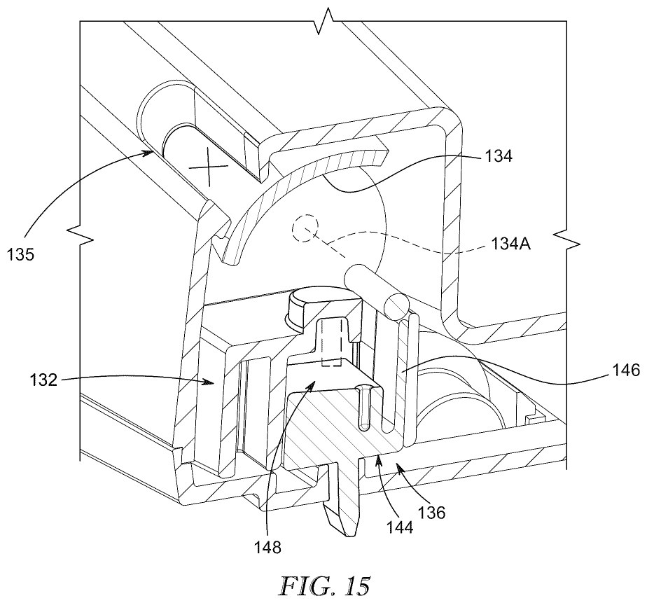

In the illustrative embodiment, the translation system 16 further includes a position indicator 130 configured to visually indicate when the juvenile-seat shuttle 20 is in the transportation position and when the juvenile-seat shuttle 20 is not in the transportation position as shown in FIGS. 12-15. The position indicator 130 includes an indicator mount 132 coupled to the juvenile-seat shuttle 20, an indicator panel 134 coupled to the indicator mount 132, and a panel actuator 136 configured to move the indicator panel 134 relative to the indicator mount 132. The indicator panel 134 is configured to display a first visual indication through an opening 135 in the juvenile-seat shuttle 20 when the juvenile-seat shuttle is in the transportation position and a second visual indication through the opening 135 when the juvenile-seat shuttle is not in the transportation position. The panel actuator 134 is coupled to the indicator panel 134 and is movable from an actuated position to an unactuated position.

The panel actuator 136 assumes the actuated position when the juvenile-seat shuttle 20 is in the transportation position and urges the indicator panel 134 to display the first visual indication to indicate that the juvenile seat 12 is in the transportation position. The panel actuator 136 assumes the unactuated position when the juvenile-seat shuttle 20 and the juvenile seat 12 are not in the transportation position and urges the indicator panel 134 to display the second visual indication to indicate that the juvenile seat 12 is not in the transportation position. This lets caregivers know that the juvenile seat 12 should be returned to the transportation position prior to embarking on a trip in the vehicle. In the illustrative embodiment, the child restraint 10 includes a corresponding position indicator 110 on each lateral side of the juvenile-seat shuttle 20 to indicate the position of the juvenile-seat shuttle 20 and the juvenile seat 12 from both sides of the child restraint 10.

One of the rails 70 included in the plurality of rails is formed to include a slot 138 as shown in FIGS. 12-15. The slot 138 terminates at each lateral end of the rail 70 with an actuator seat 140, 142. The actuator seats 140, 142 engage each corresponding position indicator 110 when the juvenile-seat shuttle 20 is in the transportation position to cause each position indicator to display the first visual indication.

The panel actuator 136 includes an actuator post 144, a link arm 146 extending between and interconnecting the actuator post 144 and the indicator panel 134, and a biasing element 148 configured to move the actuator post 144, the link arm 146, and the indicator panel 134 relative to the juvenile-seat shuttle 20. The actuator post 144 moves relative to the juvenile-seat shuttle 20 in response to engaging one of the actuator seats 140, 142 in the transportation position. The link arm 146 transfers motion of the actuator post 144 to the indicator panel 134 to cause movement of the indicator panel 134 relative to the juvenile-seat shuttle 20 to display the first visual indication in the transportation position. In the illustrative embodiment, the actuator post 144 and the link arm 146 move in a linear, upward direction relative to the juvenile-seat shuttle 20 in response to engaging with one of the actuator seats 140, 142. The indicator panel 134 is coupled to the indicator mount 132 for pivotable movement about a panel axis 134A extending perpendicularly to the upward movement direction of the actuator post 144 and the link arm 146. The biasing element 148 is configured to urge the actuator post 144 and the link arm 146 in an opposite, downward direction to cause the indicator panel 134 to rotate in a opposite direction about panel axis 134A and display the second visual indication when the actuator post 144 is separated from the actuator seat 140, 142. The slot 138 is configured to receive at least a portion of the actuator post 144 when the juvenile-seat shuttle 20 is not in the transportation position to provide clearance for the actuator post 144. In some embodiments, the biasing element 148 includes a compression spring.

Another embodiment of a child restraint 210 is shown in FIGS. 16-24. The child restraint 210 includes a juvenile seat 212 and a seat base 214. The juvenile seat 212 is formed to include a child-receiving space (not shown) configured to hold a child for transportation in a vehicle (not shown). The seat base 214 is configured to be secured to a vehicle seat 211 to mount the juvenile seat 212 to the vehicle seat 211 during transportation in the vehicle. In some embodiments, the juvenile seat 212 may be separated from the seat base 214 for transportation away from the seat base 214 and the vehicle seat 211.

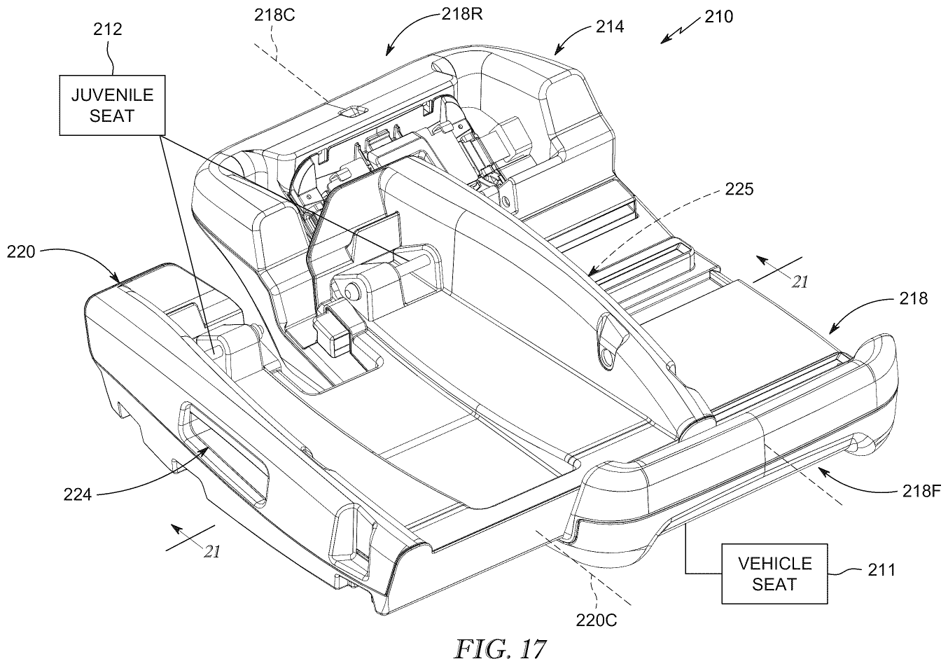

The seat base 214 includes a base foundation 218 and a juvenile-seat shuttle 220 coupled to the base foundation 218 as shown in FIGS. 16 and 17. The base foundation 218 is configured to be mounted to the vehicle seat 211 in a substantially fixed position relative to the vehicle seat 211. The juvenile-seat shuttle 220 is configured to support the juvenile seat 212 on the seat base 214.

The juvenile-seat shuttle 220 is coupled to the base foundation 218 for movement relative to the base foundation 218 between a transportation position, as shown in FIG. 16, and an ingress-egress position, as shown in FIG. 17. In the transportation position, the juvenile seat 214 and the juvenile-seat shuttle 220 overlie the base foundation 218. The base foundation 218 and the juvenile-seat shuttle 220 each have front-to-back centerlines 218C, 220C that are aligned in the transportation position. In the ingress-egress position, the juvenile-seat shuttle 220 and the juvenile seat 212 are at least partially offset from the base foundation 218 to facilitate placement or removal of a child into or out of the child-receiving space. In some embodiments, the juvenile-seat shuttle 220 and the juvenile seat 212 may be offset from the centerline 218C in the ingress-egress position such that the juvenile-seat shuttle 220 and the juvenile seat 212 project outward from the base foundation 218 more than half a width of the base foundation 218. The juvenile-seat shuttle 220 is configured to slide the juvenile seat 212 closer to, or even partially outside of, a door of the vehicle while the child restraint 10 is attached to the vehicle seat 211 so that it is easier for a caregiver to install or remove a child from the child-receiving space, or to install or remove the juvenile seat 212 from the seat base 214, while standing outside of the vehicle.

The seat base 214 further includes a shuttle lock 222 configured to retain the juvenile-seat shuttle 220 and the juvenile seat 212 in the transportation position. The shuttle lock 222 includes left and right actuator handles 224, 225 location on opposite lateral sides 220L, 220R of the juvenile-seat shuttle 220 from one another. The juvenile-seat shuttle 220 can slide linearly to the left or right upon actuation of either of the left or right actuator handles 224, 225. In some embodiments, the juvenile-seat shuttle 220 may be configured to slide linearly in a left direction 102 only upon actuation of the left actuator handle 224 and in an opposite, right direction 104 only upon actuation of the right actuator handle 225. In some embodiments, the juvenile-seat shuttle 220 may be configured to slide in either direction 102, 104 upon actuation of either actuator handle 224, 225. In some embodiments, the left and right actuator handles 224, 225 can be coupled to one another so that actuation of one of the actuator handles 224, 225 causes simultaneous actuation of the other actuator handle 224, 225.

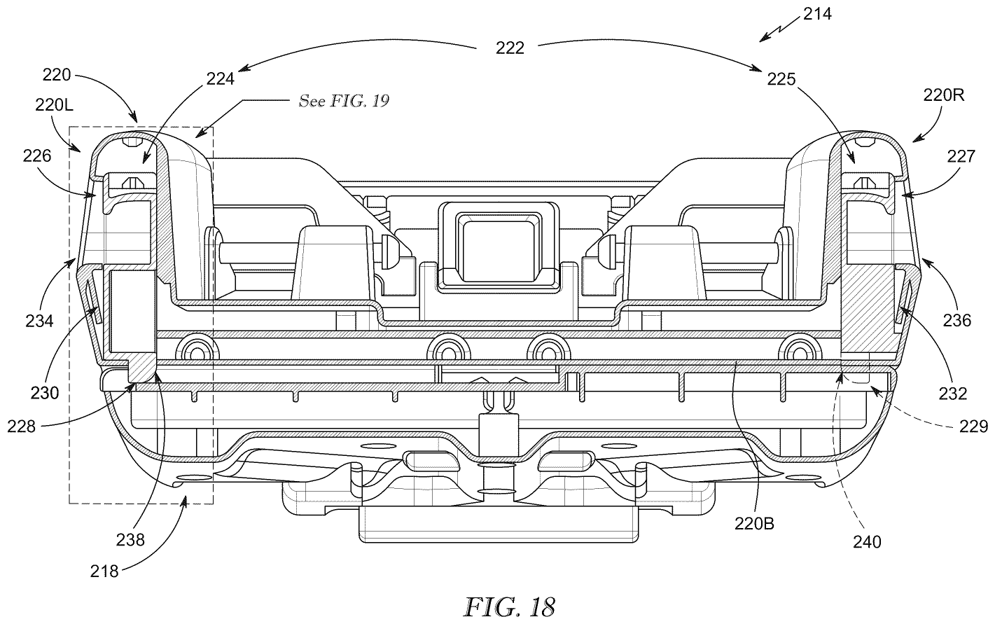

Each actuator handle 224, 225 includes a handgrip 226, 227 and a shuttle retainer 228, 229 coupled to each respective handgrip 226, 227 as shown in FIGS. 18-20. The handgrips 226, 227 are located within respective cavities 230, 232 formed in the juvenile-seat shuttle 20 and are accessible through openings 234, 236 formed in each lateral side 220L, 220R of the juvenile-seat shuttle 220. The shuttle retainers 228, 229 are coupled to lower ends of each respective handgrip 226, 227 and extend downwardly toward the base foundation 218. Each of the shuttle retainers 228, 229 is configured to extend out of each respective cavity 230, 232 through an opening 238, 240 formed in a bottom wall 220B of the juvenile-seat shuttle 220. The shuttle retainers 228, 229 are normally positioned to engage the base foundation 218 to block movement of the juvenile-seat shuttle 220 relative to the base foundation 218 from the transportation position to the ingress-egress position.

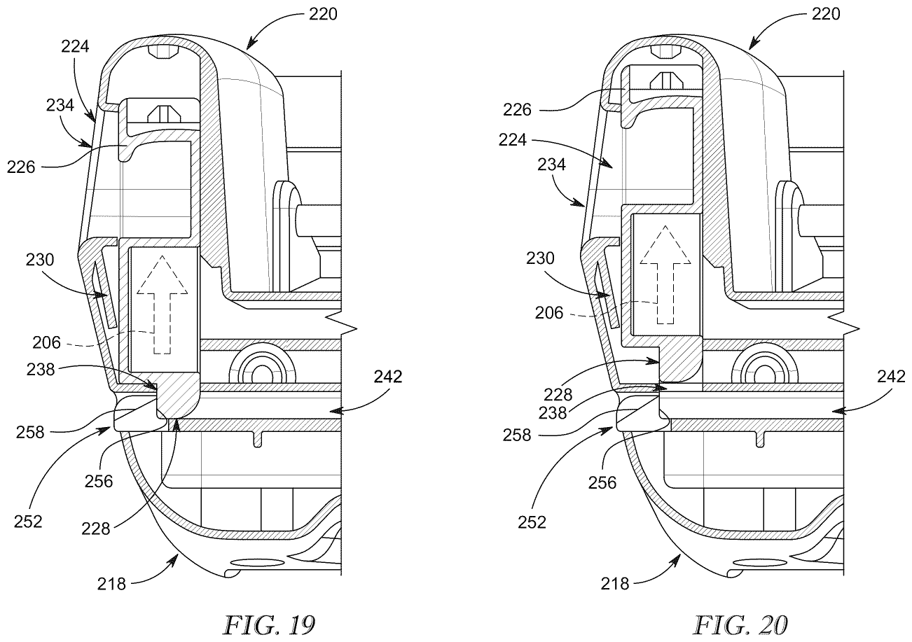

Each of the handgrips 226, 227 can be gripped and moved in an upward direction 106 away from the base foundation 218 by a user to change the shuttle lock 222 from a locked position, as shown in FIG. 19, to an unlocked position, as shown in FIG. 20. In the locked position, the each of the shuttle retainers 228, 229 extend through each respective opening 238, 240 toward the base foundation 218. Each shuttle retainer 228, 229 extends into a slot 242 formed in the base foundation 218 and will engage a portion of the base foundation 218 to block movement of the juvenile-seat shuttle 220 to the ingress-egress position. In the unlocked position, at least one of the shuttle retainers 228, 229 is removed from the slot 242 and the juvenile-seat shuttle 220 is free to slide relative to the base foundation to the ingress-egress position.

The base foundation 218 includes a foundation shell 250 and left and right motion blockers 252, 254 coupled to opposite lateral sides of the foundation shell 250. The foundation shell 250 is formed to include the slot 242 that receive the shuttle retainers 228, 229 in the locked position. Each motion-blocker 252, 254 is positioned at an outermost end of the slot 242 and includes a retaining surface 256, and a sloped surface 258. Each shuttle retainer 228, 229 is configured to bear against a respective retaining surface 256 in the locked position to block the juvenile-seat shuttle 220 from sliding relative to the base foundation 218 to the ingress-egress position. Each sloped surface 258 is configured to move the shuttle retainers 228, 229 out of the way of the base foundation 228 as the juvenile-seat shuttle 220 returns to the transportation position. In the illustrative embodiment, the actuator handles 224, 225 are biased (i.e. by a spring) downwardly toward the base foundation 218 to automatically assume the locked position when the juvenile-seat shuttle 220 returns to the transportation position.

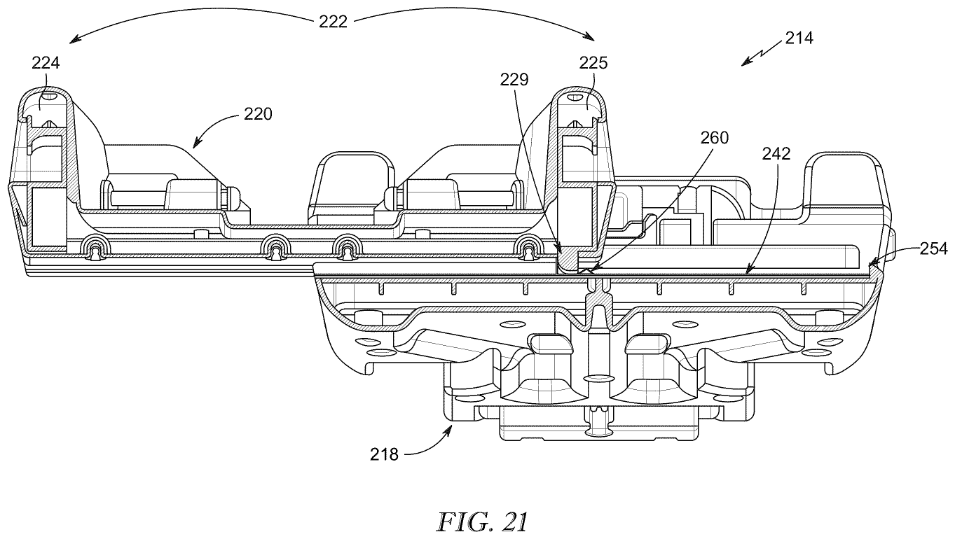

The shuttle lock 222 is also configured to retain the juvenile-seat shuttle 220 in the ingress-egress position as shown in FIG. 21. The base foundation 218 further includes at least one detent 260 configured to retain the juvenile-seat shuttle 220 in the ingress-egress position and block movement of the juvenile-seat shuttle 220 toward the transportation position. The detent 260 is located within the slot 242 and is configured to interact with one of the shuttle retainers 228, 229 to block movement of the juvenile-seat shuttle 220 toward the transportation position. The detent 260 lies vertically within a travel path of one of the shuttle retainers 228, 229 to control movement of the juvenile-seat shuttle 220 from the ingress-egress position to the transportation position.

The detent 260 includes a pair of sloped surfaces 262, 264 that are inclined toward one another. The sloped surfaces 262, 264 allow movement of the shuttle retainers 228, 229 over and past the detent in response to a lateral force 100 above a predetermined amount. The sloped surfaces 262, 264 may have different slopes relative to one another so that the predetermined amount required to overcome the detent is different when juvenile-seat shuttle travels from the transportation position to the ingress-egress position and from the ingress-egress position to the transportation position. In the illustrative embodiment, the sloped surface 64 that engages the shuttle retainer 228, 229 first as the juvenile-seat shuttle 220 moves from the transportation position to the ingress-egress position has a greater slope than the sloped surface 62 that engages the shuttle retainer 228, 229 first as the juvenile-seat shuttle 220 moves from the ingress-egress position to the transportation position. The juvenile-seat shuttle 220 may further include rollers 288 that engage and roll along the base foundation 218 to facilitate movement from between the transportation position and the ingress-egress position.

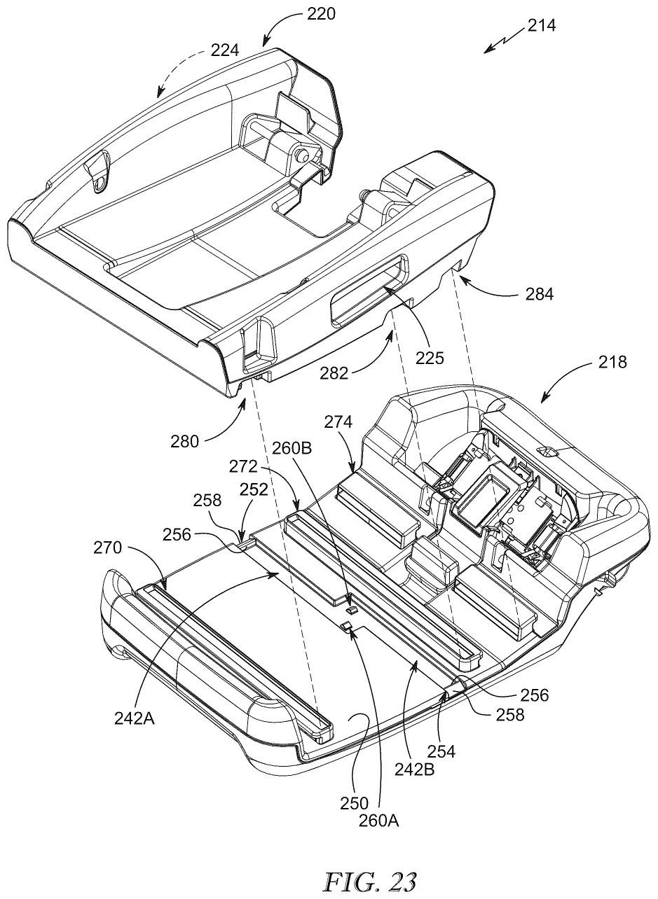

In the illustrative embodiment, slot 242 includes two portions 242A, 242B that are at least partially offset from one another as shown in FIG. 23. Each of the portions 242A, 242B of the slot 242 extends linearly from a central region of the foundation shell 250 toward a respective lateral side of the base foundation. Each of the shuttle retainers 228, 229 is configured to extend into a respective portion 242A, 242B of the slot 242 and travel therethrough. The detent 260 includes first and second detents 260A, 260B, each arranged in a respective portion 242A, 242B.

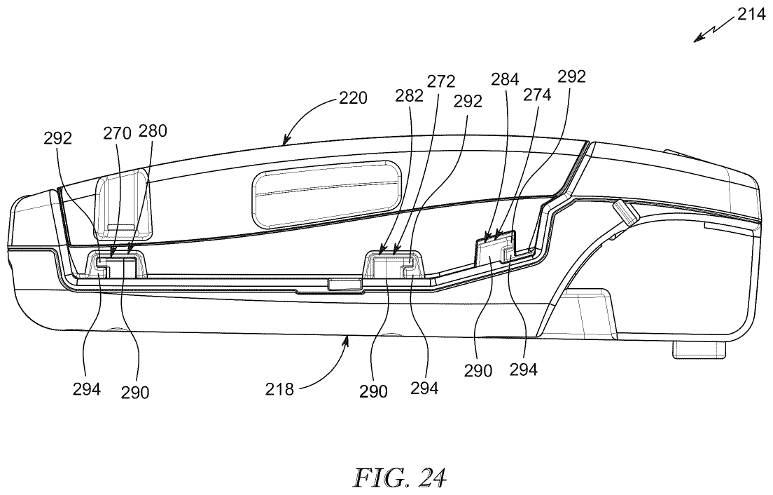

The base foundation 218 further includes a plurality of rails 270, 272, 274 coupled to an upper end of the foundation shell 250 as shown in FIGS. 23 and 24. The juvenile-seat shuttle 220 is formed to include a plurality of guide slots 280, 282, 284. Each rail 270, 272, 274 is received in a respective guide slot 280, 282, 284. The juvenile-seat shuttle 220 and the juvenile seat 212 are configured to slide laterally relative to the base foundation 218 to cause each rail 270, 272, 274 to be partially removed from each respective guide slot 280, 282, 284 in the ingress-egress position.

Each rail 270, 272, 274 includes a rail body 290 and a hanger 292 that extends horizontally away from an upper end of the rail body 290 as shown in FIGS. 23 and 24. The juvenile-seat shuttle 220 includes ledges 294 which are located beneath a respective hanger 292 to block separation of the juvenile-seat shuttle 220 from the base foundation 218 in an upward direction. In the illustrative embodiment, two rails 272, 274 are located closer to the rear end 218R of the base foundation 218 than the front end 218F to reinforce connection with the juvenile-seat shuttle 220 and bear loads acting thereon during front end impacts on the vehicle.

Another embodiment of a child restraint 310 is shown in FIGS. 25-30. The child restraint 310 includes a juvenile seat 312 and a seat base 314. The juvenile seat 312 is formed to include a child-receiving space 316 configured to hold a child for transportation in a vehicle (not shown). The seat base 314 is configured to be secured to a vehicle seat 311 to mount the juvenile seat 312 to the vehicle seat 311 during transportation in the vehicle.

The seat base 314 includes a base foundation 318 and a juvenile-seat shuttle 320 coupled to the base foundation 318 as shown in FIGS. 25 and 26. The base foundation 318 is configured to be mounted to the vehicle seat 311 in a substantially fixed position relative to the vehicle seat 311. The juvenile-seat shuttle 320 is configured to support the juvenile seat 312 on the seat base 314.

The juvenile-seat shuttle 320 is coupled to the base foundation 318 for movement relative to the base foundation 318 between a transportation position, as shown in FIG. 25, and an ingress-egress position, as shown in FIG. 26. In the transportation position, the juvenile seat 314 and the juvenile-seat shuttle 320 overlie the base foundation 318 and are aligned with a front-to-back centerline 318C of the base foundation 318. In the ingress-egress position, the juvenile-seat shuttle 320 and the juvenile seat 312 are at least partially offset from the base foundation 318 to facilitate placement or removal of a child into or out of the child-receiving space 316. In some embodiments, the juvenile-seat shuttle 320 and the juvenile seat 312 may be offset from the centerline 318C in the ingress-egress position such that the juvenile-seat shuttle 320 and the juvenile seat 312 project outward from the base foundation 318 more than half a width of the base foundation 318. The juvenile-seat shuttle 320 is configured to slide the juvenile seat 312 closer to, or even partially outside of, a door of the vehicle while the child restraint 310 is attached to the vehicle seat 311 so that it is easier for a caregiver to install or remove a child from the child-receiving space 316, or to install or remove the juvenile seat 312 from the seat base 314, while standing outside of the vehicle.

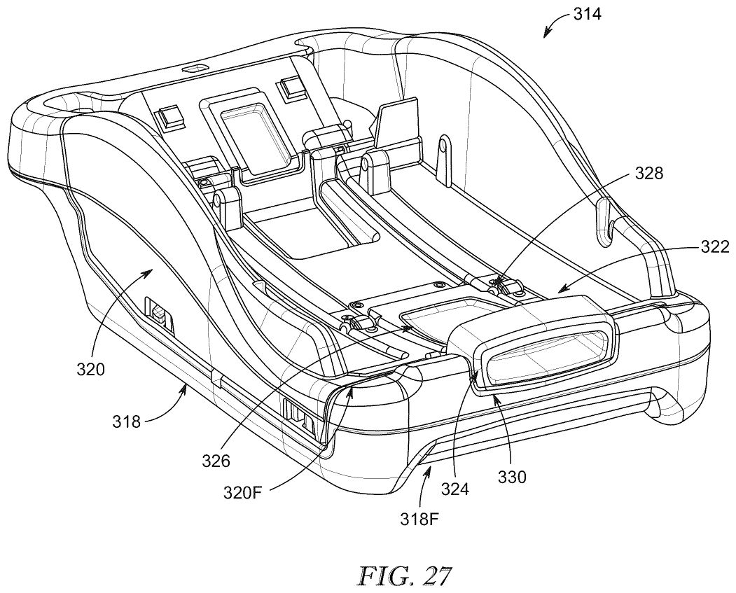

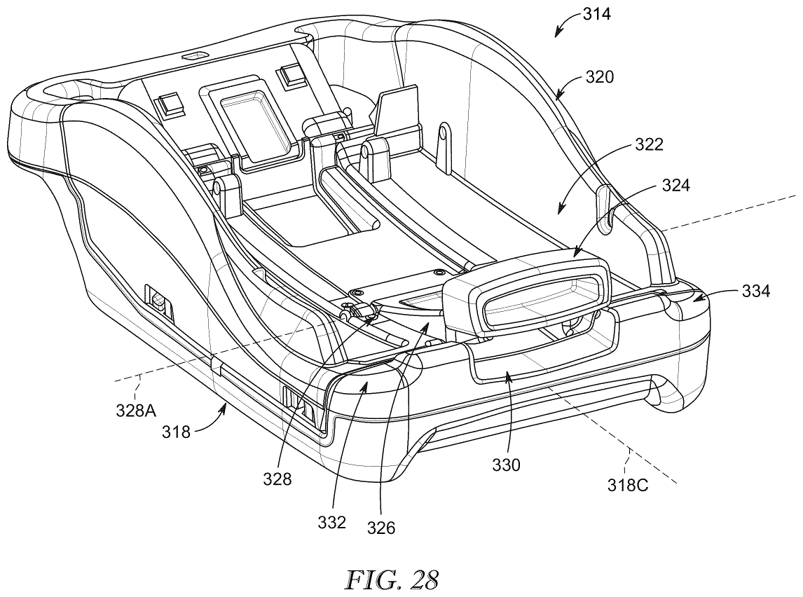

The seat base 314 further includes a shuttle lock 322 configured to retain the juvenile-seat shuttle 320 and the juvenile seat 312 in the transportation position. The shuttle lock 322 includes a handgrip 324, a handle arm 326 coupled to the handgrip 324, and an axle 328 coupled between the juvenile-seat shuttle 320 and the handle arm 326. The handgrip 324 is located at a front end 320F of the juvenile-seat shuttle 320. The handle arm 326 extends rearwardly away from the front end 320F of the juvenile-seat shuttle 320 and resides beneath the juvenile seat 312 when the juvenile seat 312 is attached to the seat base 314. The axle 328 is coupled between the juvenile-seat shuttle 320 and the handle arm 326 to allow pivotable movement of the shuttle lock 322 between a locked position, as shown in FIG. 27, and an unlocked position, as shown in FIG. 28.

In the locked position, the handgrip 324 and/or the handle arm 326 engage the base foundation 318 to block movement of the juvenile-seat shuttle 320 relative to the base foundation 318. In the unlocked position, the handgrip 324 and at least a portion of the handle arm 326 are separated from the base foundation 318 and the juvenile-seat shuttle 320 is free to move relative to the base foundation 318 to the ingress-egress position. The juvenile-seat shuttle 320 is free to travel in either lateral direction when the shuttle lock 322 is in the unlocked position.

A front end 318F of the base foundation 318 is formed to include a slot 330 as shown in FIGS. 27 and 28. At least one of the handgrip 324 and the handle arm 326 is arranged to lie within the slot 330 in the locked position to block movement of the juvenile-seat shuttle 320 relative to the base foundation 318. The handgrip 324 and the handle arm 326 are removed from the slot 330 in the unlocked position to allow movement of the juvenile-seat shuttle 320 relative to the base foundation 318. The handgrip 324 and the handle arm 326 are pivotable relative to the juvenile-seat shuttle 320 about a horizontal pivot axis 328A provided by the axle 328 in an upward direction to the unlocked position. The handgrip 324 and the handle arm 326 are biased in an opposite, downward direction toward the locked position by one or more springs, for example.

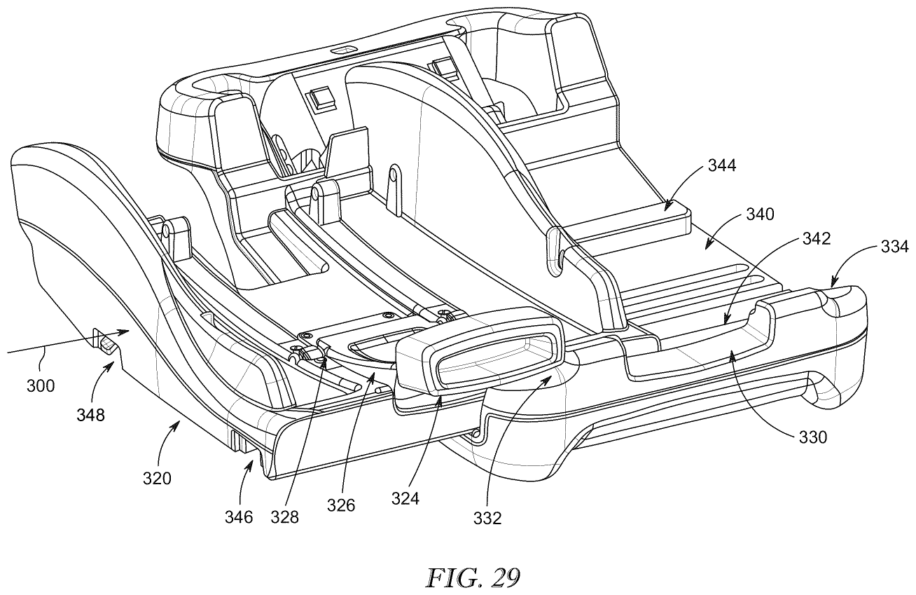

The shuttle lock 322 is also configured to retain the juvenile-seat shuttle 20 in the ingress-egress position as shown in FIG. 29. The front end 318F of the base foundation 318 includes a first and a second slopped corners 332, 334 located on opposite lateral sides from one another. The first and second sloped corners 332, 334 are inclined toward one another and toward the slot 330, which is spaced equal distances from both corners 332, 334. The first and the second slopped corners 332, 334 provide a detent when the juvenile-seat shuttle 320 is in the ingress-egress position to block movement of the juvenile-seat shuttle 320 toward the transportation position.

The juvenile-seat shuttle 320 is movable from the ingress-egress position to the transportation position in response to a lateral force 100 inwardly toward the slot 330 above a predetermined amount. Lateral forces 100 above the predetermined amount are sufficient to overcome the spring force and/or gravity holding the shuttle lock 322 in a lowered position in interference with one of the sloped corners 332, 334. The lateral force 100 causes the handgrip 324 and the handle arm 326 to ride inwardly along the sloped corner 332, 334 and eventually rise above the sloped corner 332, 334 without the user touching and lifting the shuttle lock 322. Once the shuttle lock 322 is realigned with the slot, the spring or gravity return the handgrip 324 and/or handle arm 326 within the slot 330 to block movement of the juvenile-seat shuttle 320 relative to the base foundation 318.

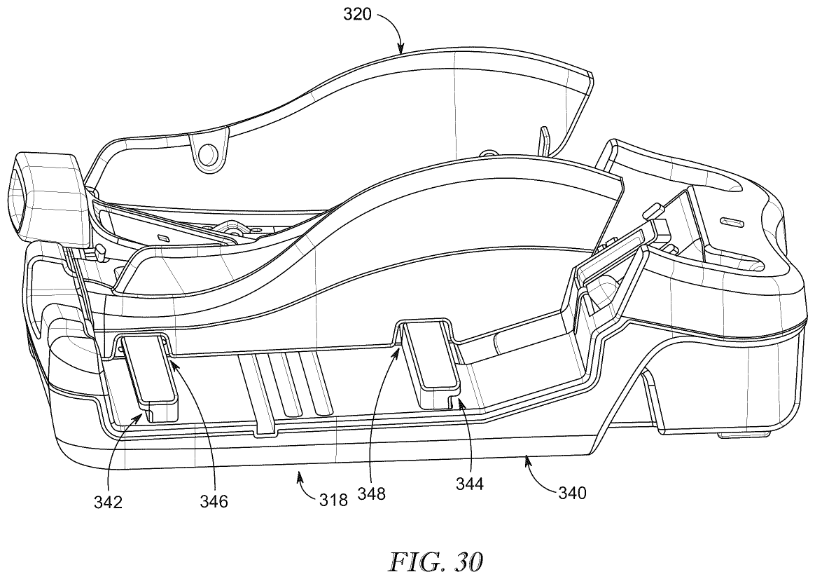

The base foundation 18 includes a foundation shell 340 and a plurality of rails 342, 344 coupled to an upper end of the foundation shell 340 as shown in FIGS. 29 and 30. The juvenile-seat shuttle 320 is formed to include a plurality of guide slots 346, 348. Each rail 340, 342 included in the plurality of rails is received in a respective guide slot 346, 348. The juvenile-seat shuttle 320 and the juvenile seat 312 are configured to slide laterally relative to the base foundation 328 to cause each rail 342, 344 to be partially removed from each respective guide slot 346, 348 in the ingress-egress position.

1. A child restraint comprising
a juvenile seat formed to include a child-receiving space configured to hold a child for transportation in a vehicle,
a seat base configured to be secured to a vehicle seat to mount the juvenile seat to the vehicle seat during transportation in the vehicle, and
a translation system configured to support the juvenile seat on the seat base and allow movement of the juvenile seat relative to the seat base between a transportation position, in which the juvenile seat lies along a front-to-back centerline of the seat base, and an ingress-egress position in which a front-to back centerline of the juvenile seat is offset from the front-to-back centerline of the seat base to facilitate placement or removal of a child into or out of the child-receiving space, or installation or removal of the juvenile seat to or from the seat base,
wherein the translation system includes a juvenile-seat shuttle coupled to the seat base and configured to engage with the juvenile seat to support the juvenile seat on the seat base for movement between the transportation position and the ingress-egress position, a shuttle-guide system coupled between the juvenile-seat shuttle and the seat base and configured to guide sliding movement of the juvenile-seat shuttle and the juvenile seat relative to the seat base in a lateral direction between the transportation position and the ingress-egress position, and a shuttle lock configured to block selectively movement of the juvenile-seat shuttle relative to the seat base between the transportation position and the ingress-egress position.

2. The child restraint of claim 1, wherein the shuttle lock includes a first actuator coupled to a first lateral side of the juvenile-seat shuttle and a second actuator coupled to a second lateral side of the juvenile-seat shuttle opposite the first lateral side, wherein the first actuator is configured to move from a locked position to an unlocked position to free the juvenile-seat shuttle to slide in a first lateral direction to arrange the juvenile-seat shuttle in a first ingress-egress position, and wherein the second actuator is configured to move from a locked position to an unlocked position to free the juvenile-seat shuttle to slide in a second lateral direction opposite the first lateral direction to arrange the juvenile-seat shuttle in a second ingress-egress position.

3. The child restraint of claim 2, wherein the first and second actuators each include a handgrip and a shuttle retainer coupled to a lower end of the handgrip and configured to engage the seat base in the locked position to block movement of the juvenile-seat shuttle from the transportation position to first and second ingress-egress positions.

4. The child restraint of claim 3, wherein the shuttle retainer of the first actuator is configured to block the juvenile-seat shuttle from moving to the transportation position when the juvenile-seat shuttle is in the second ingress-egress position, and the shuttle retainer of the second actuator is configured to block the juvenile-seat shuttle from moving to the transportation position when the juvenile-seat shuttle is in the first ingress-egress position.

5. The child restraint of claim 3, wherein the seat base is formed to include a slot configured to receive the shuttle retainer of the first and second actuators when the juvenile-seat shuttle is in the transportation position and the first and second actuators are in the locked position, and the shuttle lock further includes a motion-blocking unit having a first motion blocker located at a first lateral end of the slot and configured to engage the shuttle retainer of the first actuator and a second motion blocker located at a second lateral end of the slot and configured to engage the shuttle retainer of the second actuator.

6. The child restraint of claim 5, wherein the seat base is formed to include a plurality of rails in the slot and each shuttle retainer includes a plurality of teeth configured to interlock with the plurality of rails.

7. The child restraint of claim 5, wherein the shuttle lock further includes a detent unit located in the slot and configured to engage one of the shuttle retainers when the juvenile-seat shuttle is in the ingress-egress position to block movement of the juvenile-seat shuttle from the ingress-egress position to the transportation position.

8. The child restraint of claim 7, wherein the detent unit includes a first detent configured to engage the shuttle retainer of the second actuator when the juvenile-seat shuttle is in the first ingress-egress position and a second detent configured to engage the shuttle retainer of the first actuator when the juvenile-seat shuttle is in the second ingress-egress position.

9. The child restraint of claim 1, wherein shuttle-guide system includes a plurality of rails coupled to an upper end of the seat base and a plurality of shuttle anchors coupled to the juvenile-seat shuttle and configured to engage with at least one of the rails included in the plurality of rails to retain the juvenile-seat shuttle to the seat base.

10. The child restraint of claim 9, wherein the juvenile-seat shuttle is formed to include a plurality of guide slots, each rail included in the plurality of rails is received in a respective guide slot, and each shuttle anchor included in the plurality of shuttle anchors defines at least a portion of a respective guide slot and engages a respective rail included in the plurality of rails to block separation of the juvenile-seat support from the seat base.

11. The child restraint of claim 9, wherein the shuttle-guide system further includes a plurality of rollers coupled to the juvenile-seat shuttle and configured to engage the seat base and roll along the seat base as the juvenile-seat shuttle changes from the transportation position to the ingress-egress position.

12. The child restraint of claim 9, wherein the plurality rails includes a first rail located between a rear end of the seat base and a side-to-side centerline of the seat base extending perpendicular to the front-to-back centerline, a second rail located between the first rail and the side-to-side centerline of the seat base, and a third rail located between a front end of the seat base and the side-to-side centerline of the seat base, and
wherein the plurality of shuttle anchors includes a first shuttle anchor configured to interlock with the first rail and extending toward the side-to-side centerline, a second shuttle anchor configured to interlock with the second rail and extending toward the side-to-side centerline, and a third shuttle anchor configured to interlock with the third rail and extending toward the side-to-side centerline.

13. The child restraint of claim 9, wherein the shuttle-guide system further includes a translation limiter spaced apart from the shuttle lock and configured to engage the seat base when the juvenile-seat shuttle is in the ingress-egress position to block further translation of the juvenile-seat shuttle relative to the seat base.

14. The child restraint of claim 13, wherein the juvenile-seat shuttle is formed to include a first limiter-receiving slot and the seat base is formed to include a second limiter-receiving slot aligned with the first limiter-receiving slot to define a limiter cavity therebetween, and wherein the translation limiter is positioned in the limiter cavity and is configured to slide relative to the seat base and the juvenile-seat shuttle as the juvenile-seat shuttle moves between the transportation position and the ingress-egress position.

15. The child restraint of claim 14, wherein the translation limiter includes an upper limiter body engaged with the juvenile-seat shuttle and configured to slide relative to the juvenile-seat shuttle, a lower limiter body engaged with the seat base and configured to slide relative to the seat base, and a spring configured to bias the upper limiter body toward the juvenile-seat shuttle and the lower limiter body toward the seat base.

16. The child restraint of claim 15, wherein the lower limiter base includes a first plurality of ribs and the seat base is formed to include a second plurality of ribs configured to interlock with the first plurality of ribs.

17. The child restraint of claim 1, wherein the translation system further includes a position indicator configured to visually indicate when the juvenile-seat shuttle is in the transportation position and when the juvenile-seat shuttle is not in the transportation position.

18. The child restraint of claim 17, wherein the position indicator includes an indicator mount coupled to the juvenile-seat shuttle, an indicator panel coupled to the indicator mount and configured to display a first visual indication when the juvenile-seat shuttle is in the transportation position and a second visual indication when the juvenile-seat shuttle is not in the transportation position, and a panel actuator coupled to the indicator panel and movable from an actuated position, in which the juvenile-seat shuttle is in the transportation position and urges the indicator panel to display the first visual indication, and an unactuated position when the juvenile-seat shuttle is not in the transportation position and the panel actuator urges the indicator panel to display the second visual indication.

19. The child restraint of claim 18, wherein the shuttle-guide system includes a plurality of rails coupled to the seat base, and wherein one of the rails is formed to include a slot configured to receive at least a portion of the panel actuator when the juvenile-seat shuttle is not in the transportation position to provide clearance for the panel actuator to urge the indicator panel to display the second visual indication.

20. The child restraint of claim 18, wherein the panel actuator includes an actuator post configured to move relative to the indicator mount between the actuated and unactuated positions and a spring configured to urge the actuator post toward the unactuated position to cause the indicator panel to normally display the second visual indication.
